(19) United States
(12) Patent Application Publication
(10) Pub. No.: US 2023/0281236 A1
(43) Pub. Date: Sep. 7, 2023

(54) SEMANTIC SEARCH SYSTEMS AND METHODS

(71) Applicant: NICE LTD, Ra'anana (IL)

(72) Inventors: Naomi ZEICHNER, Mizra (IL); Tal HAGUEL, Petach Tikva (IL)

(21) Appl. No.: 17/684,034

(22) Filed: Mar. 1, 2022

(51) Int. Cl. G06F 16/35; G06F 16/93; G06F 40/30; G06F 40/279

(52) U.S. Cl. CPC G06F 16/355; G06F 16/93; G06F 40/30; G06F 40/279

(57) ABSTRACT

Semantic search systems and methods, and non-transitory computer readable media, include receiving divided text of at least two participants from a customer interaction; applying a clustering algorithm to the divided text to create a plurality of word clusters per participant, wherein each word cluster comprises topic words, phrases, or sentences; applying a word-embedding algorithm to the topic words, phrases, or sentences in each word cluster to produce a numeric representation of each word cluster; and storing the numeric representation of each word cluster and the topic words, phrases, or sentences in each word cluster in a document.

### TECHNICAL FIELD

The present disclosure relates generally to methods and systems for semantic searching that help a user obtain additional and important information for the text searched, and more specifically relates to methods and systems of semantic searching that use a clustering algorithm and a word-embedding algorithm to produce a numeric representation of a word cluster and return only part of a document in a search.

### BACKGROUND

Conversations that take place in a call center (also referred to as a contact center) tend to be long and contain a lot of information. When any user (such as an agent or an analyst) needs to search for a phrase or term within the conversation, the user typically has two options. First, the user can use keyword or phrase searching, which searches for the exact keyword or exact phrase match in a transcription of an audio or chat interaction. The second option is to use semantic searching, which provides the user the ability to search within the transcription and receive not only the exact word/phrase that the user searched, but also other words and phrases with a similar meaning in the context of the interaction.

Elasticsearch is a common search engine that provides the option of semantic searching using the dense vector feature by calculating the cosine similarity between the embedding vector of the user search phrase and the embedding of the entire text of an interaction. As transcriptions of audio/chat interactions tend to be quite long, this leads to low quality representation of the content as well as high storage and bandwidth during search. This, in turn, leads to poor user experience.

A possible solution is to split the transcription into sequential segments such as a sentence or a paragraph, but this method poses several problems in Elasticsearch. First, it produces an undetermined number of segments, while Elasticsearch requires the number to be preset. Second, it results in a large number of segments, making the search time longer.

Accordingly, a need exists for improved systems and methods for efficiently and quickly semantic searching.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a data flow according to various aspects of the present disclosure.

FIG. 2 is a flowchart of a method according to embodiments of the present disclosure.

FIG. 3 illustrates an exemplary index structure of a document according to embodiments of the present disclosure.

FIG. 4A and FIG. 4B illustrate exemplary search results according to embodiments of the present disclosure.

FIG. 5 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods address the issues of low quality, high bandwidth, high storage, and long search time. The present disclosure describes the use of distributed semantic clustering of the text of a customer interaction at the time of indexing, which allows the retrieval of only the semantically related parts of the text during searching and pre-setting the number of segments or clusters ahead of time, while maintaining high quality and good performance As explained in more detail below, in one or more embodiments, the present systems and methods split the text of a customer interaction into smaller portions such as sentences and/or by participants to create a defined number of clusters of common topic words, which are then stored alongside the text of the customer interaction. In some embodiments, text of a customer interaction is split into different parts, which are each embedded separately, stored separately, and returned separately. Advantageously, the present systems and methods provide high quality (e.g., the ability to have larger vector sizes due to more vectors), lower bandwidth and storage, and better response time.

As described above, a user can use a keyword/phrase search or a semantic search when looking for a word or a phrase within a customer interaction. The keyword/phrase search requires an exact keyword/phrase match in the text of the customer interaction. The semantic search, on the other hand, provides the ability to search the meaning of a word or phrase within the text and receive not only the exact word/phrase that was searched, but also other words or phrases with a similar meaning in the context of the text.

For example, assume the following text is present in a customer interaction, “I am very angry with your service, and I would like to close my account.” If a user searches for the word “cancel,” the keyword/phrase search would not return a hit on this sentence. On the other hand, with semantic search, the user will receive a hit because the word “close” was used in a similar meaning to the search word “cancel.”

In various embodiments, the present methods include an ingest phase, where text from a customer interaction is processed and stored in a database. In this phase, by splitting or dividing text of a customer interaction according to business logic, and by having a static structure of the index before storing the document, better comprehensive quality is achieved. In certain embodiments, text of a customer interaction (e.g., a chat interaction, an email interaction, or an audio interaction such as a phone call) is received and preprocessed to remove unnecessary words and/or change a word to its root word (Lemma). Preprocessing generally results in the same amount of sentences, but fewer words in the sentences. Once the text of the interaction is preprocessed, the text can be divided by participant. In several embodiments, the text of each participant is optionally further divided into sentences. In one or more embodiments, a clustering algorithm is applied to each participant's text (e.g., sentences) to create a plurality of word clusters per participant. For example, if the interaction includes two participants (e.g., a customer and an agent), running the clustering algorithm on the customer's text and the agent's text would provide the subject matter that was discussed during the interaction. In one embodiment, the output of the clustering algorithm is a list of topics for the customer and a list of topics for the agent. Each topic in the list can be represented by one or more topic words, phrases or sentences. After applying the clustering algorithm, a word-embedding algorithm is applied to the topic words. phrases or sentences in each word cluster to produce a numeric representation of each word cluster. In other words, the word-embedding algorithm is run in the context of the word's neighboring words. Finally, the numeric representation of each word cluster and the text representation of each word cluster (i.e., the topic words, phrases, or sentences) are stored in a document within a database. In an exemplary embodiment, the database is associated with the Elasticsearch search engine.

In certain embodiments, the present methods also include a search phase, where a user enters a word or a phrase to search. According to one or more embodiments, a word-embedding algorithm is applied to the word or the phrase to produce a numeric representation of the term or the phrase. Next, a cosine similarity score between the numeric representation of the term or phrase and the stored numeric representation of each word cluster is calculated. The documents that include a word cluster with a high score of cosine similarity (e.g., a cosine similarity score above a threshold score) can be obtained, and the document ID, along with a topic word, phrase, or sentence of the relevant word cluster can be returned as search results to the user. In various embodiments, the search results are sorted according to cosine similarity score, and the search results are displayed in descending order of cosine similarity score.

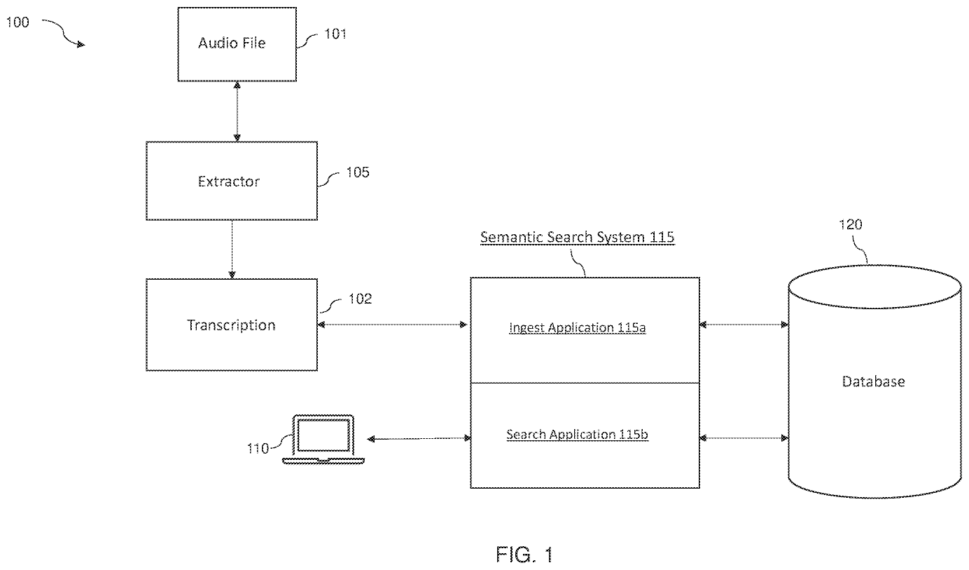

FIG. 1 illustrates a block diagram of an exemplary data flow and system according to embodiments of the present disclosure. The system 100 includes an audio file 101, a transcription 102, an extractor service 105, a client browser 110, a semantic search system 115 including an ingest application 115a and a search application 115b, and a database 120. Once an audio file 101 of a customer interaction is created, an extractor service 105 loads the audio file and runs a transcription of each audio file. The transcription 102 is saved at a centralized location. The transcription 102 is then fed into the semantic search system 115, where ingest application 115a reads the text of the transcription 102, divides the text of transcription 102 by participant, creates word clusters for each participant, runs a word-embedding algorithm on each word cluster to produce a numeric representation of each word cluster, and stores the word clusters and the numeric representations on a relevant index in database 120. In an exemplary embodiment, the database 120 is associated with the Elasticsearch search engine.

Once a user is logged in to system 100 and opens a search page on the client browser 110, the user will have the ability to run a search and enter a search term/phrase/sentence. The search for a specific term/phrase/sentence is relayed to search application 115b, where the specific term/phrase/sentence is read and a word-embedding algorithm is run on every word of the specific term/phrase/sentence to produce a numeric representation of the specific term/phrase/sentence. Search application 115b then calculates a cosine similarity score between the numeric representation of the specific term/phrase/sentence and stored numeric representations of word clusters in database 120. Search application 115b finds the documents in database 120 having a word cluster that, when compared to the numeric representation of the specific term/phrase/sentence, has a cosine similarity score above a threshold cosine similarity score.

In several embodiments, the entire document is not returned to the user, but only the document ID and the topic word, phrase, or sentence of the word cluster is returned to client browser 110. Once the results are displayed on client browser 110 and returned to the user, the user can create a different search or combination of search terms. The user can also listen to the relevant interactions (e.g., calls) that correspond to the results that return as each result returns with its document ID, which is the call identified in the interaction.

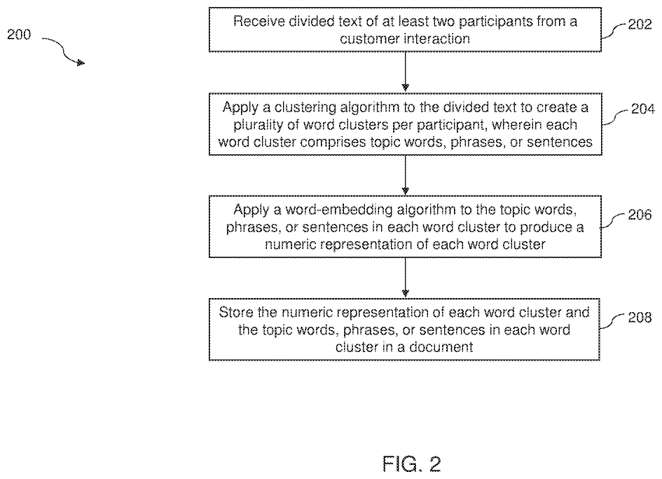

Referring now to FIG. 2, a method 200 according to embodiments of the present disclosure is described. At step 202, semantic search system 115 via ingest application 115a receives divided text of at least two participants from a customer interaction. In some embodiments, the at least two participants are a customer and an agent. In certain embodiments, a mono recording of the customer interaction is received, and the divided text is obtained as described in U.S. Pat. No. 9,300,801, which is incorporated herein by express reference thereto.

In some embodiments, ingest application 115a first receives a transcription 102 of the customer interaction and preprocesses the text of the transcription. In one embodiment, preprocessing includes cleaning up the text to remove words and punctuation that are not relevant to the subject matter of the text. Exemplary text might be [“Hi, I'm calling to change my credit card number, can you please assist me?” ] After preprocessing, the text is abbreviated into a more elementary semantic version, such as [“Calling change credit card number please assist.” ]

In various embodiments, ingest application 115a divides the text of the transcription between the at least two participants of the customer interaction. In some embodiment, ingest application 115 divides the text into sentences. For example, if the text is, [“Hello, you've reached the contact center, my name is tal, how can I help you? My name is Jon, I would like to update my account.” ] After splitting, the text is: [Agent: “Hello, you've reached the contact center, my name is tal, how can I help you?” ] and [Customer: “My name is Jon, I would like to update my account.” ]

At step 204, ingest application 115a applies a clustering algorithm to the divided text to create a plurality of word clusters per participant. Each word cluster includes a plurality of topic words, phrases, or sentences. Word clustering involves the task of grouping a set of unlabeled words in such a way that words in the same group (called a cluster) are more similar to each other than those in other clusters. Any suitable text or word clustering algorithm may be used in this step 204.

In one embodiment, the clustering algorithm is the k-nearest neighbors (KNN) algorithm. The KNN algorithm assumes that similar things exist in close proximity. In other words, similar things are close to each other. For example, bed and mattress and sleeping bag, while different words with different meanings, have similar or overlapping meanings. The KNN algorithm captures the idea that similarity (sometimes called distance, proximity, or closeness) can be found by calculating the distance between points on a graph.

For example, assume the text is [“I had some connection issues with my internet, how can I transfer some money?” ]. Where k=2, [transfer, money] would be grouped in one cluster, and [connection, issue, internet] would be grouped in a second cluster. Advantageously, even with a low number of clusters (e.g., 2), good quality results are still typically obtained. In several embodiments, the number of clusters is configurable. In some embodiments, k (or the number of clusters) is about 2-10.

In another embodiment, the clustering algorithm is a k-means clustering algorithm. The k-means algorithm is an iterative algorithm that tries to partition the data set into k predefined distinct non-overlapping subgroups (clusters), where each data point belongs to only one group. In some embodiments, the number of clusters k is configurable. The higher the number of clusters, the greater the precision, but the worse the user experience is during a search.

At step 206, ingest application 115a applies a word-embedding algorithm to the topic words, phrases, or sentences in each word cluster to produce a numeric representation of each word cluster. Generally, when a user wants to search semantically, the user needs to have a numeric representation of the text that is stored and the text that the user wants searched. Word embedding is one of the most popular representations of document vocabulary. It is capable of capturing the context of a word in a document, semantic and syntactic similarity, and relation with other words. In one embodiment, the word-embedding algorithm uses the context of the three (3) words on the right of the relevant word and the context of the three (3) words on the left of the relevant text. Word embeddings are typically vector representations of a particular word.

Referring back to the example above, for each word within each cluster, a word-embedding algorithm is run to produce a vector. For example, the cluster [transfer, money] can be run through a word-embedding algorithm to output the vector [0.2, 0.001, −1.2, −0.9, 0, 0], and the cluster [connection, issue, internet] when run through a word-embedding algorithm could output the vector [0.4, 0.01, −1.5, −0.9, −1.4, −0.7]. In various embodiments, the output vector of each word cluster should be the same size. For example, for the cluster [transfer, money], 0 was added so that the vector includes six features.

The vector length of each word is the features size. In one or more embodiments, a user wants high quality, so the vector length includes a high number of features. For example, the vector length can include 100 features so that each word in each word cluster is represented by 100 features. In another embodiment, the vector length can include about 2 to about 20 features.

In another example, there can be two features per word in each cluster. Take, for instance, the text: [“I had some problem with my credit card.” ] After applying a clustering algorithm, the output cluster is [some, problem, credit, card]. After applying a word-embedding algorithm, the output vector is [0.001, 0.003, 0.4, 1.1, −0.2, 2.1, −0.8, −0.2], where each word in the cluster is represented by two features.

At step 208, ingest application 115a stores the numeric representation of each word cluster and the topic words, phrases, or sentences in each word cluster in a document. In other words, the word cluster embedding and the word text representation of each cluster is stored.

According to one or more embodiments, a document for each customer interaction that contains several parts per participant is produced, each part having a numeric representation. In various embodiments, the numeric representation and textual representation of the interaction (e.g., the topic word(s) of the word cluster), along with the full text of the interaction is stored as a document on the ElasticSearch search engine, which can then be used for search purposes.

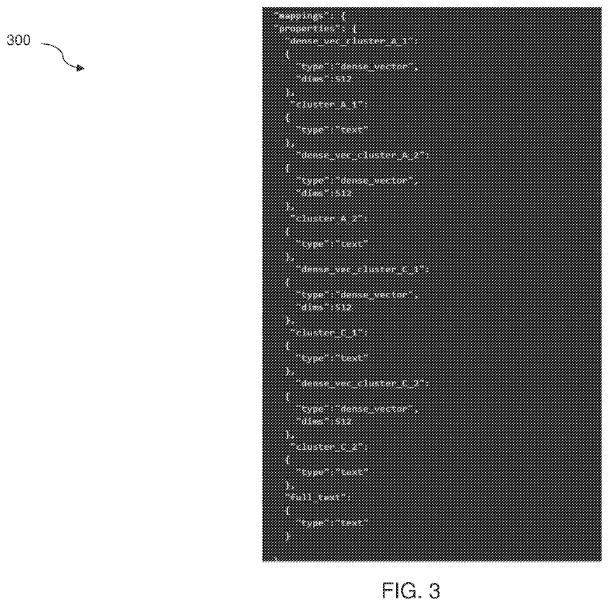

FIG. 3 is an exemplary index structure 300 of a document that is stored. The index structure 300 is divided into clusters for an agent (e.g., dense_vec_cluster_A_1 and dense_vec_cluster_A_2) and clusters for a customer (e.g., dense_vec_cluster_C_1 and dense_vec_cluster_C_2). Cluster_A_1 and cluster_A_2 are each a text representation of the topic words that relate to each agent part, while cluster_C_1 and cluster_C_2 are each a text representation of topic words that relate to each customer part. The total vector size is 512 numeric values (“type”: “dense vector”, “dims”: 512). Index structure 300 also includes the full text of the interaction (“full_text”: “type”: “text”).

The below illustrates how a full document can be stored, with each cluster represented by a vector and stored alongside the relevant text.

{{‘dense_vec_cluster_A_1’: [−0.035656820982694626, −0.03319571912288666,
0.0704742893576622, 0.07324134558439255, 0.01744631864130497, −
0.0014029995072633028, 0.03884357586503029, −0.050957873463630676, −
0.03680857643485069, 0.04114794358611107, 0.03955468535423279,
0.04435863345861435, 0.013390855863690376, 0.038355570286512375, −
0.03016854077577591, 0.05971658602356911, −0.009698532521724701,
0.0451822355389595, −0.005981894675642252, −0.019192568957805634,
0.028538988903164864, −0.016551656648516655, 0.0814380794763565, −
0.01916709914803505, −0.02849951572716236, 0.05756181478500366, −
0.01890493929386139, −0.09157459437847137, 0.019972514361143112, −, −
0.01718044839799404, 0.026221588253974915, −0.10437234491109848, −
0.03353523090481758, −0.00394597090780735, −0.09325043112039566, −
0.016704320907592773, −0.022325770929455757, 0.10596950352191925, −
0.06410612165927887, −, 0.017249900847673416, −0.012399083003401756, −
0.04777942970395088, −0.012182744219899178, −0.08347323536872864, −
0.0636080801486969, −0.020792953670024872, −0.022509673610329628],
‘cluster_A_1’: ‘calling contact center, help’, ‘dense_vec_cluster_A_2’: [−
0.035656820982694626, −0.03319571912288666, 0.0704742893576622,
0.07324134558439255, 0.01744631864130497, −0.0014029995072633028,
0.03884357586503029, −0.050957873463630676, −0.03680857643485069,
0.04114794358611107, 0.03955468535423279, 0.04435863345861435,
0.013390855863690376, 0.038355570286512375, −
0.03016854077577591,...0.09312094748020172, 0.008761310018599033,
0.008435867726802826, −0.003066824981942773, 0.04928221181035042, −
0.009603464044630527, 0.031606387346982956, 0.09698472917079926, −
0.0881628543138504, −0.04672500491142273, −0.06540944427251816,
0.07641193270683289, −0.022334612905979156, −0.024858834221959114,
0.04232999309897423, 0.0007309648208320141, 0.060247790068387985,
0.00792037881910801, −0.003415890736505389, −0.022191746160387993, −
0.02253836765885353, 0.02691807597875595, 0.06953618675470352,
0.045719798654317856, −0.024450406432151794, −, −0.0636080801486969, −
0.020792953670024872, −0.022509673610329628], ‘cluster_A_2’: ‘reset, internet
modem’, ‘dense_vec_cluster_C_1’: [−0.035656820982694626, −
0.03319571912288666, 0.0704742893576622, 0.07324134558439255,
0.01744631864130497, −0.0014029995072633028, 0.03884357586503029, −
0.050957873463630676, −0.03680857643485069,... −0.03876044228672981, −
0.0018545787315815687, −0.020792953670024872, −0.022509673610329628],
‘cluster_C_1’: ‘problem with access, account’, ‘dense_vec_cluster_C_2’: [−
0.035656820982694626, −0.03319571912288666, 0.0704742893576622,
0.07324134558439255, 0.01744631864130497, −0.0014029995072633028,
0.03884357586503029, −0.050957873463630676, −0.03680857643485069,
0.04114794358611107, 0.03955468535423279, 0.04435863345861435,
0.013390855863690376, 0.038355570286512375, −0.03016854077577591,
0.05971658602356911, −0.009698532521724701, 0.0451822355389595, −
0.005981894675642252, −0.019192568957805634, 0.028538988903164864, −
0.016551656648516655, 0.0814380794763565, −0.01916709914803505, −
0.02849951572716236, 0.05756181478500366, −0.01890493929386139, −
0.09157459437847137, 0.019972514361143112, −0.0048120166175067425, .....,
0.004956456832587719, −−0.022509673610329628], ‘cluster_C_2’: ‘assist,
working’, ‘full_text’: “thank you for calling x contact center ,my name is
jon how can I help you? Thank you, my name is Dan, I have some problems to
access my account, can you please assist me? Sure, reset your internet modem
and try again. thanks it's working.

In one or more embodiments, search application 115b receives a search term or a search phrase from a user, for example, through client browser 110. Search application 115b then applies a word-embedding algorithm on the search term or the search phrase to produce a numeric representation of the search term or the search phrase. For example, if the search term is “phone,” the numeric representation of “phone” could be [0.2, 0.001, −1.2, −0.9, 0, 0]. Search application 115a takes the numeric representation and calculates the cosine similarity score between this numeric representation and the stored numeric representation of each word cluster. Cosine similarity measures the cosine of the angle between two vectors projected in a multi-dimensional space. The smaller the angle, the higher the cosine similarity. Mathematically, the cosine of the angle between such vectors should be positive and close to 1, i.e., the angle should be close to zero. Below is a request example to calculate the cosine similarity score:

Request example:

‘{“query”: {“script_score”: {“query”: {“match_all”: { }},
“script”: {“source”:
“cosineSimilarity(params.query_vector,\‘dense_vec_cluster_A_1\’)+ 1.0”,
“params”: {“query_vector”: [−0. 07731068879365921, 0.030056877061724663,
0.010201736353337765, 0.03846975043416023, 0.017434872686862946,
0.02643708698451519, 0.08949887752532959, −0.03117852658033371,.........
0.08638819307088852, 0.04611184820532799, −0.024181783199310303,
0.0626642256975174,]}}}}}’

In one or more embodiments, search application 115b establishes a threshold cosine similarity score. In one embodiment, only those documents that include a stored numeric representation of a word cluster having a cosine similarity score that is above the threshold cosine similarity score are returned to the user. In addition, in some embodiments, only the document ID, the words of the word cluster that has the highest score, and the other scores sorted in descending order are displayed to the user. In certain embodiments, the user can request all the relevant clusters and the document ID, along with the full text of the relevant part of the interaction where the word of the word cluster appears. In various embodiments, the number of search results is configurable. For example, the user can specify that he or she only wants the top X number of results, or can ask for all the results.

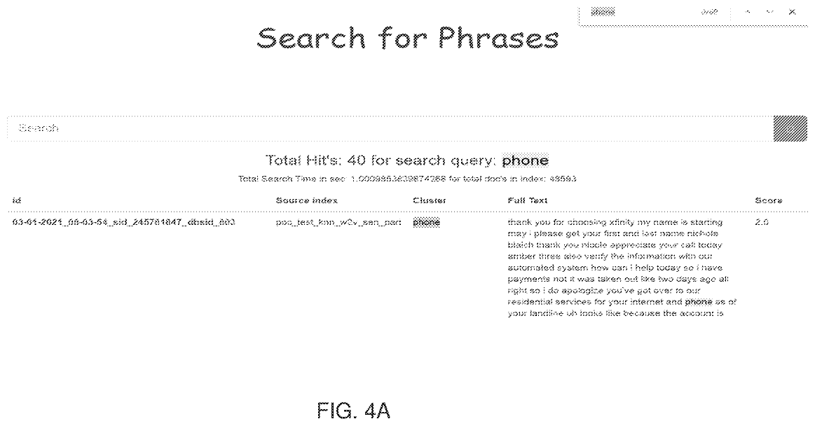

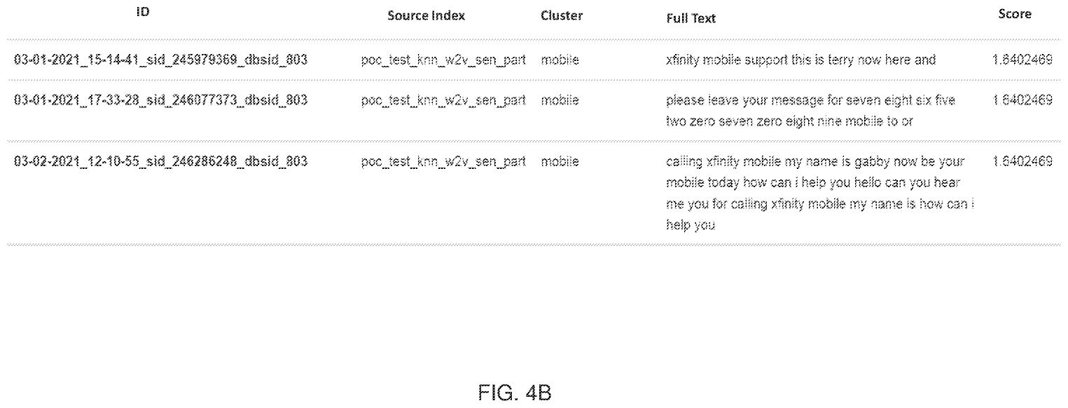

FIG. 4A provides an example search result where the search term is phone. As can be seen, the document ID, the source index, the word of the word cluster, the full text of the relevant part of the interaction, and the cosine similarity score are provided to the user.

FIG. 4B provides another example of search results where the search term is “phone,” but the search results also return hits that include “mobile.” Again, the search results include the document ID, the source index, the word of the word cluster, the full text of the relevant part of the interaction, and the cosine similarity score.

Below are performance results from a sample run of the method 200 using real customer data.

TABLE 1
PERFORMANCE RESULTS

| | | | Search | | | |
|---|---|---|---|---|---|---|
| | Ingest | Search all | threshold | Search top | | Total |
| Flow run | time | time | time* | 100 time | Quality* | Storage |
| Present | *~600 ms | ~377 sec | ~12 sec | ~3.5 sec | 65% | ~33.5 GB |
| approach | (per file) | | | | | |
| Elastic | ~250 ms | ~500 sec | NA (Time | ~5 sec | 60% | ~33.5 GB |
| approach | (per file) | | out) | | | |

The ingest phase was implemented as a multi-threaded ingestion. The search was run over 750,000 customer interactions, with an average 6-minute duration for each interaction. The threshold cosine similarity score was set to 1.5 (or 75% of what the system is sure of) A higher threshold cosine similarity score would likely have reduced the time to provide the results.

Returning fewer results would reduce the time as well. For example, if there are 100 results with a score of 0-2, and only the top 10 results (the 10 highest scores) are displayed, then the time to provide the results is also reduced

As shown from the above, there was a better time for providing search results (by at least 20%). The relevant part of the document was returned in the search, and the initial results indicated better quality. In addition, there was reduced storage and bandwidth depending on the configuration.

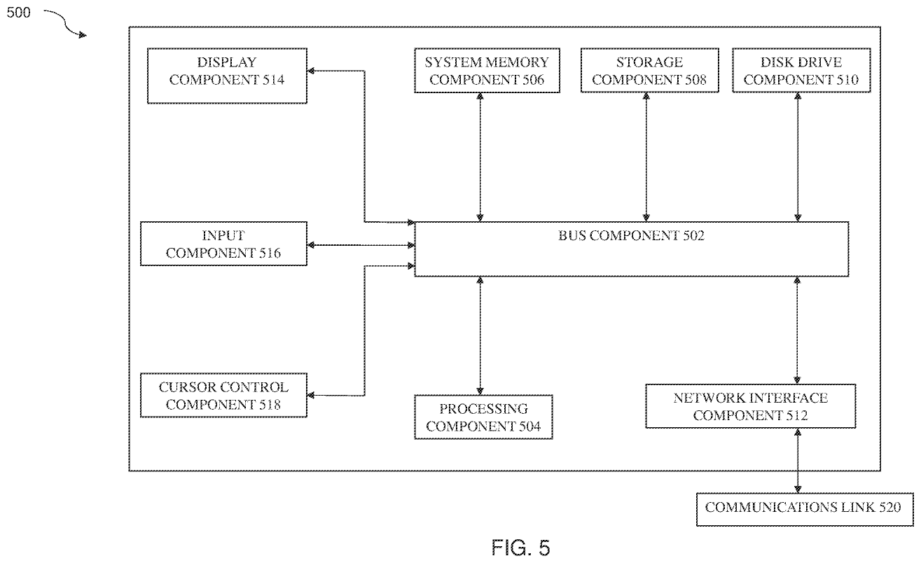

Referring now to FIG. 5, illustrated is a block diagram of a system 500 suitable for implementing embodiments of the present disclosure. System 500, such as part a computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to receive divided text of at least two participants from a customer interaction; apply a clustering algorithm to the divided text to create a plurality of word clusters per participant, wherein each word cluster comprises topic words, phrases, or sentences; apply a word-embedding algorithm to the topic words, phrases, or sentences in each word cluster to produce a numeric representation of each word cluster; and store the numeric representation of each word cluster and the topic words, phrases, or sentences in each word cluster in a document. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A semantic search system comprising:
a processor and a computer readable medium operably coupled thereto, the computer readable medium comprising a plurality of instructions stored in association therewith that are accessible to, and executable by, the processor, to perform operations which comprise:
receiving divided text of at least two participants from a customer interaction;
applying a clustering algorithm to the divided text to create a plurality of word clusters per participant, wherein each word cluster comprises topic words, phrases, or sentences;
applying a word-embedding algorithm to the topic words, phrases, or sentences in each word cluster to produce a numeric representation of each word cluster; and
storing the numeric representation of each word cluster and the topic words, phrases, or sentences in each word cluster in a document.

2. The semantic search system of claim 1, wherein the operations further comprise:
receiving a transcription of the customer interaction;
preprocessing text of the transcription; and
dividing the text of the transcription between the at least two participants of the customer interaction.

3. The semantic search system of claim 1, wherein the operations further comprise:
receiving a search term or a search phrase from a user;
applying a word-embedding algorithm on the search term or the search phrase to produce a numeric representation of the search term or the search phrase;
calculating a cosine similarity score between the numeric representation of the search term or the search phrase and the stored numeric representation of each word cluster;
establishing a threshold cosine similarity score;
obtaining a document that includes a stored numeric representation of a word cluster having a cosine similarity score that is above the threshold cosine similarity score; and
displaying a word of the word cluster and a document ID for the document.

4. The semantic search system of claim 3, wherein the operations further comprise storing full text of a transcription of the customer interaction.

5. The semantic search system of claim 4, wherein the operations further comprise displaying full text of the transcription associated with the document, the cosine similarity score associated with the document, or both.

6. The semantic search system of claim 4, wherein the operations further comprise:
obtaining a plurality of documents that each include a stored numeric representation of a word cluster having a cosine similarity score that is above the threshold cosine similarity score; and
ranking each of the plurality of documents based on its respective cosine similarity score.

7. The semantic search system of claim 6, wherein the operations further comprise displaying a word of a word cluster and a document ID for each of the plurality of documents in descending order of cosine similarity score.

8. The semantic search system of claim 1, wherein the clustering algorithm comprises a k-means clustering algorithm.

9. The semantic search system of claim 1, wherein the numeric representation of each word cluster comprises a numeric representation of each word in each word cluster, and the numeric representation of each word comprises a vector.

10. A method of semantic searching, which comprises:
receiving divided text of at least two participants from a customer interaction;
applying a clustering algorithm to the divided text to create a plurality of word clusters per participant, wherein each word cluster comprises topic words, phrases, or sentences;
applying a word embedding algorithm to the topic words, phrases, or sentences in each word cluster to produce a numeric representation of each word cluster; and
storing the numeric representation of each word cluster and the topic words, phrases, or sentences in each word cluster in a document.

11. The method of claim 10, which further comprises:
receiving a transcription of the customer interaction;
preprocessing text of the transcription; and
dividing the text of the transcription between the at least two participants of the customer interaction.

12. The method of claim 10, which further comprises:
receiving a search term or a search phrase from a user;
applying a word embedding algorithm on the search term or the search phrase to produce a numeric representation of the search term or the search phrase;
calculating a cosine similarity score between the numeric representation of the search term or the search phrase and the stored numeric representation of each word cluster;
establishing a threshold cosine similarity score;
obtaining a document that includes a stored numeric representation of a word cluster having a cosine similarity score that is above the threshold cosine similarity score; and
displaying a word of the word cluster and a document ID for the document.

13. The method of claim 12, which further comprises storing full text of a transcription of the customer interaction.

14. The method of claim 13, which further comprises displaying full text of the transcription associated with the document, the cosine similarity score associated with the document, or both.

15. The method of claim 10, which further comprises:
obtaining a plurality of documents that each include a stored numeric representation of a word cluster having a cosine similarity score that is above the threshold cosine similarity score; and
ranking each of the plurality of documents based on its respective cosine similarity score.

16. The method of claim 15, which further comprises displaying a word of a word cluster and a document ID for each of the plurality of documents in descending order of cosine similarity score.

17. A non-transitory computer-readable medium having stored thereon computer-readable instructions executable by a processor to perform operations which comprise:
receiving divided text of at least two participants from a customer interaction;
applying a clustering algorithm to the divided text to create a plurality of word clusters per participant, wherein each word cluster comprises topic words, phrases, or sentences;
applying a word embedding algorithm to the topic words, phrases, or sentences in each word cluster to produce a numeric representation of each word cluster; and
storing the numeric representation of each word cluster and the topic words, phrases, or sentences in each word cluster in a document.

18. The non-transitory computer-readable medium of claim 17, wherein the operations further comprise:
receiving a search term or a search phrase from a user;
applying a word embedding algorithm on the search term or the search phrase to produce a numeric representation of the search term or the search phrase;
calculating a cosine similarity score between the numeric representation of the search term or the search phrase and the stored numeric representation of each word cluster;
establishing a threshold cosine similarity score;
obtaining a document that includes a stored numeric representation of a word cluster having a cosine similarity score that is above the threshold cosine similarity score; and
displaying a word of the word cluster and a document ID for the document.

19. The non-transitory computer-readable medium of claim 18, wherein the operations further comprise:
storing full text of a transcription of the customer interaction; and
displaying full text of the transcription associated with the document, the cosine similarity score associated with the document, or both.

20. The non-transitory computer-readable medium of claim 19, wherein the operations further comprise:
obtaining a plurality of documents that each include a stored numeric representation of a word cluster having a cosine similarity score that is above the threshold cosine similarity score;
ranking each of the plurality of documents based on its respective cosine similarity score; and
displaying a word of a word cluster and a document ID for each of the plurality of documents in descending order of cosine similarity score.
